(19) United States
(12) Patent Application Publication
(10) Pub. No.: US 2010/0002304 A1
(43) Pub. Date: Jan. 7, 2010

(54) OPTICAL FILTER AND PLASMA DISPLAY DEVICE HAVING THE SAME

(76) Inventors: Cha-Won Hwang, Suwon-si (KR); Do-Hyuk Kwon, Suwon-si (KR); Sang-Mi Lee, Suwon-si (KR); Seung-Goo Baek, Suwon-si (KR)

Correspondence Address: CHRISTIE, PARKER & HALE, LLP, PO BOX 7068, PASADENA, CA, 91109-7068, US

(21) Appl. No.: 12/495,559

(22) Filed: Jun. 30, 2009

(30) Foreign Application Priority Data
Jul. 1, 2008 (KR) 10-2008-0063363

(51) Int. Cl. G02B 5/28; G02B 1/10

(52) U.S. Cl. 359/580

(57) ABSTRACT

An optical filter and a plasma display device including the same are provided. The optical filter includes a support layer, and a plurality of stripe-shaped structures arranged at predetermined intervals on one surface of the support layer and formed using a material having a different refractive index than a refractive index of the support layer. In the optical filter, incident light is reflected at an interface between the support layer and the structure due to a difference of the respective refractive indices. Since the direction of entry of external light is the same as the reflected exit direction of the external light, visibility degradation caused by interference from the external light is minimized or reduced. Since the structure is formed using a material having a high transmittance, luminance loss of light generated by the display is also minimized.

### CROSS-REFERENCE TO RELATED APPLICATIONS

This application claims priority to and the benefit of Korean Patent Application No. 10-2008-0063363, filed on Jul. 1, 2008, in the Korean Intellectual Property Office, the entire content of which is incorporated herein by reference.

### BACKGROUND

1. Field of the Invention

An embodiment of the present invention relates to an optical filter applied to a flat panel display device such as a plasma display device, and a plasma display device having the same.

2. Description of Related Art

A plasma display panel (PDP) is a flat panel display device that displays texts or images by allowing fluorescent materials to emit light using plasma generated from gas discharge. PDPs reproduce natural colors and have a relatively fast driving speed, and have larger display area and are thinner in depth than cathode ray tubes (CRTs). Therefore, PDPs have come into the spotlight as a next-generation display device.

However, since electromagnetic waves and strong near-infrared light are radiated from PDPs when plasma is generated by high voltage, the human body may be harmed and electronic devices may malfunction due to the electromagnetic waves. Further, color purity is affected by near-infrared light, and therefore image quality may be degraded.

Accordingly, methods of mounting optical filters on PDPs are used to shield electromagnetic waves and near-infrared light, to decrease reflected light, and to increase color purity.

### SUMMARY OF THE INVENTION

Accordingly, an aspect of the present invention provides an optical filter capable of minimizing or reducing visibility degradation caused by interference of external light, and a plasma display device having the same.

Another aspect of the present invention provides an optical filter capable of minimizing or reducing luminance loss and a plasma display device having the same.

According to an aspect of an embodiment of the present invention, an optical filter is provided, including: a support layer; and a plurality of stripe-shaped structures on one surface of the support layer and including a material having a refractive index different from a refractive index of the support layer, wherein incident light is reflected at an interface between the support layer and each of the plurality of stripe-shaped structures due to the different refractive indices.

According to another aspect of an embodiment of the present invention, a plasma display device is provided, including: a plasma display panel including a plurality of sustain electrodes, each of the plurality of sustain electrodes paired with a corresponding one of a plurality of scan electrodes, a plurality of address electrodes crossing the plurality of sustain electrodes and the plurality of scan electrodes, and a plurality of discharge spaces at crossing regions of the plurality of address electrodes with the plurality of sustain electrodes and the plurality of scan electrodes; and an optical filter on the plasma display panel, the optical filter including: a support layer; and a plurality of stripe-shaped structures on one surface of the support layer and including a material having a refractive index different from a refractive index of the support layer, wherein incident light is reflected at an interface between the support layer and each of the plurality of stripe-shaped structures due to the different refractive indices.

The optical film of the present invention may be configured so that light incident through the structure is reflected at the interface between the support layer and the structure due to a difference of refractive indices.

In the optical filter according to certain embodiments of the present invention, the structure is formed of a material having a high transmittance, and the optical filter may reduce regions with limited viewing angles, when compared with a conventional optical filter. Further, the optical filter of the present invention has reduced luminance loss, increasing the degree of freedom in designing an electric circuit and gas partial pressure.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of an optical filter according to an embodiment of the present invention.

FIG. 2 is a cross-sectional view taken along the line l1-l2 of FIG. 1.

FIG. 3 is a cross-sectional view of an optical filter according to another embodiment of the present invention.

FIG. 4 is an exploded perspective view of a plasma display device having an optical filter according to an embodiment of the present invention.

FIGS. 5A and 5B are cross-sectional views illustrating examples of reflection paths of external light.

### DETAILED DESCRIPTION OF EXEMPLARY EMBODIMENTS

In the following detailed description, certain exemplary embodiments of the present invention are shown and described by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it may be directly on the other element, or be indirectly on the other element, with one or more intervening elements interposed therebetween. Also, when an element is referred to as being “connected to” another element, it may be directly connected to the other element, or may alternatively be indirectly connected to the other element with one or more intervening elements interposed therebetween. Hereinafter, like reference numerals refer to like elements.

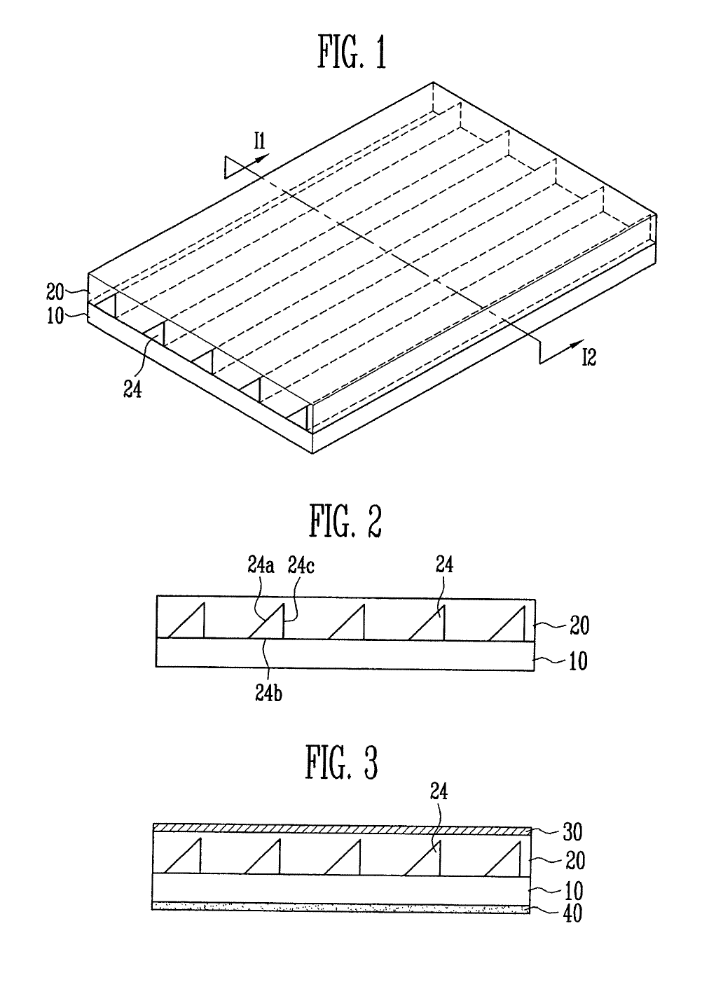

FIG. 1 is a perspective view of an optical filter according to an embodiment of the present invention, and FIG. 2 is a cross-sectional view taken along line l1-l2 of FIG. 1.

The optical filter according to an embodiment of the present invention includes a support layer 10, and a plurality of structures 24 arranged at intervals (e.g., predetermined intervals) on one surface of the support layer 10, and made of a material having a different refractive index from the support layer 10.

The support layer 10 is a base layer of the optical filter. The support layer 10 preferably has a transmittance of over 90%, a low reflectance, heat-resistive properties and a predetermined strength. For example, in one embodiment, the support layer 10 may be manufactured using a transparent film made of glass, a plastic material, or a similar material, which has a transmittance of over 90%. Plastic materials may include, for example, polyethylene terephthalate (PET), cellulose triacetate (TAC), polycarbonate (PC), or polymethyl methacrylate (PMMA).

The structure 24 reflects incident light. The structure 24 includes a first surface 24a which receives incident light, configured to be at an angle to the support layer 10; a second surface 24b opposite to the support layer 10; and a third surface 24c that allows light reflected from an interface between the support layer 10 and the structure 24 to be reflected back through the first surface 24a. The structure 24 may be formed of a transparent inorganic material, such as a glass having a transmittance of over 80%, a plastic material, a silicon, or a copolymer thereof. Plastic materials may include, for example, polyethylene terephthalate (PET), cellulose triacetate (TAC), polycarbonate (PC) and polymethyl methacrylate (PMMA).

For example, the support layer 10 may be made of an optical polyethylene terephthalate (PET) having a transmittance of 95% and a refractive index of about 1.46 to 1.52. The structure 24 may be of a stripe shape, having a triangular section with a transmittance of 90% to 95% and a refractive index of 1.55 to 1.6.

In an embodiment of the present invention, any of the first, second and third surfaces 24a, 24b and 24c of the structure 24 may be colored, thereby enhancing reflection efficiency. The structures 24 may be housed in a transparent layer 20 disposed on one surface of the support layer 10. Like the support layer 10, the transparent layer 20 preferably has a transmittance of over 90% to minimize or reduce loss of transmitted light.

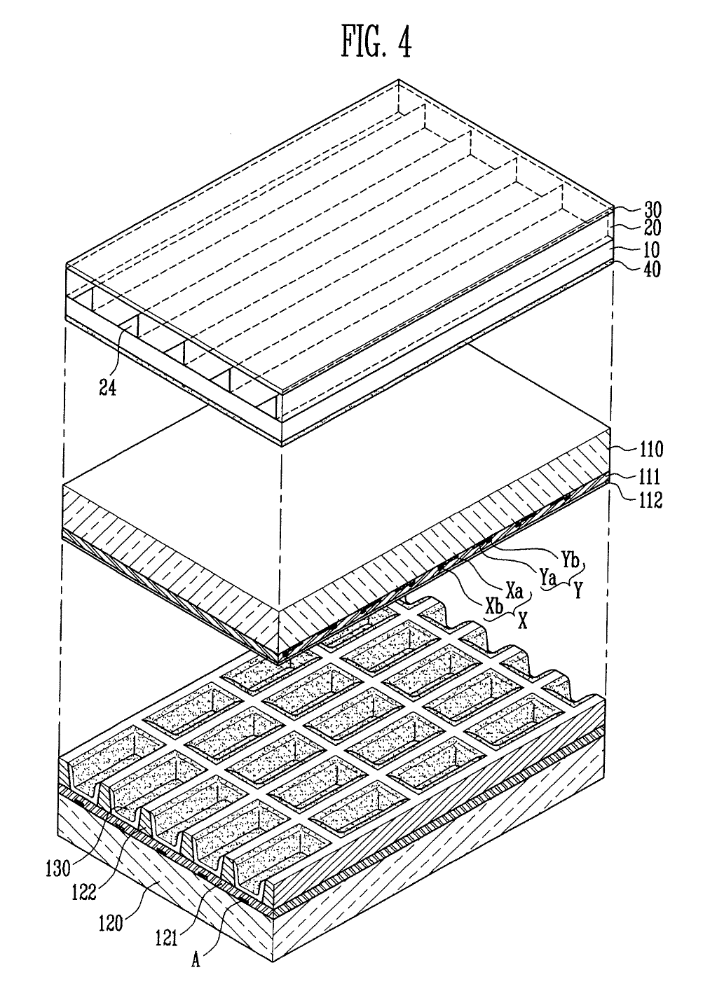

FIG. 3 is a cross-sectional view of an optical filter according to another embodiment of the present invention.

Referring to FIG. 3, a functional layer 30 may be formed on one surface of a support layer 10. The functional layer 30 may be an anti-reflection layer for reducing light reflected from the structures 24 or transparent layer 20, or a hard coating layer (e.g., a protective layer) for preventing scratches and maintaining an external shape. On the other surface of the support layer 10 may be formed an electromagnetic wave shielding layer (not shown) for shielding electromagnetic waves radiated from a display device or an adhesion layer 40 for adhesion to a display panel.

FIG. 4 is an exploded perspective view of a plasma display device to which an optical filter according to an embodiment of the present invention may be applied. A three-electrode surface discharge plasma display panel to which an optical filter may be applied will be described as an example.

Referring to FIG. 4, the plasma display panel includes first and second substrates 110 and 120 disposed opposite to each other.

A plurality of sustain electrode lines X and scan electrode lines Y covered by a dielectric 111 and a protective layer 112 are formed in parallel on the first substrate 110. The sustain electrode line X and the scan electrode line Y include transparent electrodes Xₐ and Yₐ formed of indium tin oxide (ITO) or a similar material, and metal electrodes X_{b} and Y_{b} for increasing conductivity.

A plurality of address electrode lines A covered by a dielectric 121 are formed on the second substrate 120. Barrier ribs 122 are formed in parallel and/or crossed with the plurality of address electrode lines A on the dielectric 121 between the address electrode lines A. In other words, the Barrier ribs 122 can form stripe type cells or rectangular type cells in different embodiments.

The first and second substrates 110 and 120 are joined together so that the sustain electrode lines X and the scan electrode lines Y cross perpendicularly with the address electrodes A. A gas for forming plasma is sealed in closed discharge spaces at the crossing regions enclosed by the barrier ribs 122, thereby forming a plurality of pixels.

An optical filter according to an embodiment of the present invention may be attached on the first substrate 110 of the plasma display panel configured as described above. An optical filter, for example, the optical filter as shown in FIG. 3, may be adhered to the first substrate 110 by the adhesion layer 40.

When the refractive indices of two adjacent media are different from each other, incident light is refracted at an interface between the two media. According to an embodiment of the present invention, structures 24 are formed, with a material having a refractive index different from a refractive index of support layer 10, adjacent one surface of the support layer 10. Light passing through the transparent layer 20 and incident on the structure 24 is reflected and/or refracted through the structure 24 and at the interface between the support layer 10 and the structure 24 due to the different refractive indices.

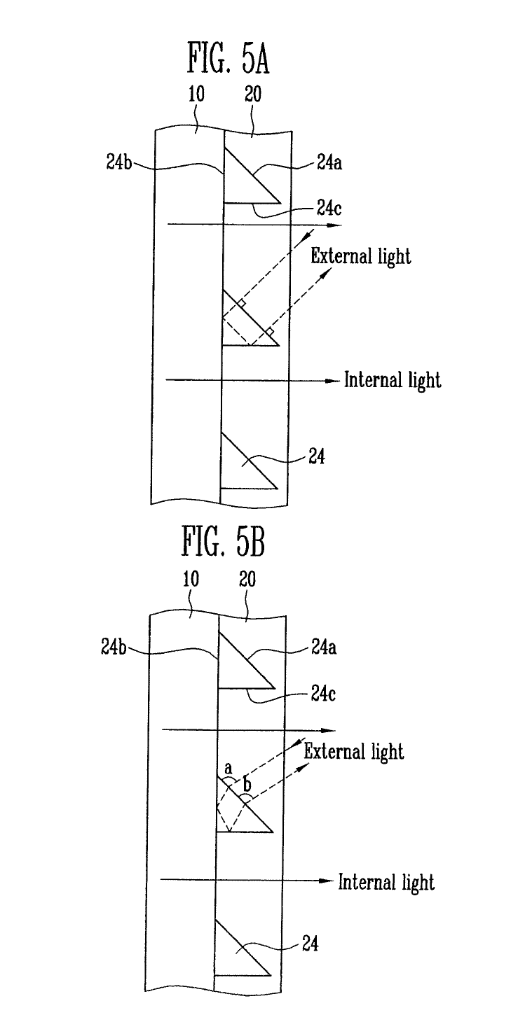

Referring to FIGS. 5A and 5B, the optical filter is in an upright position, in which the first surface 24a faces upward. In the illustrated embodiment, the first surface 24a forms an obtuse angle with a surface of the support layer 10 while facing upward. External light incident on the structure 24 passes through the first surface 24a of the structure 24, and is reflected at an interface between the second surface 24b and the support layer 10 due to the difference of refractive indices between the support layer 10 and the structure 24. Light reflected at the interface between the second surface 24b and the support layer 10 is reflected onto the third surface 24c and then reflected and radiated outwards back through the first surface 24a. In this embodiment, the structure 24 is formed so that the direction of entry of external light is the same (or substantially the same) as the reflected exit direction of the external light. However, it should be apparent that the entry and reflected directions of external light may be arbitrarily controlled by adjusting the angles formed between the first, second and third surfaces 24a, 24b and 24c, depending on the refractive indices of the support layer 10 and the structure 24. For example, if the angle formed between the second and third surfaces 24b and 24c is acute, reflection may not be optimized. Therefore, the angle formed between the second and third surfaces 24b and 24c is preferably 90 degrees or more in the described embodiment.

In FIG. 5A, external light enters perpendicularly through the first surface 24a, and in FIG. 5B, external light enters at a different angle through the first surface 24a. As can be seen in FIG. 5A, the light entering perpendicularly through the first surface 24a is reflected at the interface between the second surface 24b and the support layer 10, and is then reflected by the third surface 24c to exit through the first surface 24a. As can be seen in FIG. 5B, the light entering at an angle “a” through the first surface 24a is refracted at the first surface 24a and is then reflected at the interface between the second surface 24b and the support layer 10, and is then reflected by the third surface 24c to exit through the first surface 24a. Here, the light is refracted again at the first surface 24a and exit at angle “b” that is the same as angle “a”. As such, when the structure 24 has a right triangular cross section, the entry angle “a” of the external light is the same as the reflected exit angle “b” of the external light. However, when the structure 24 has, for example, an isosceles triangular cross section, the exit angle “b” becomes a difference of the entry angle “a” with respect to the first surface 24a, i.e., 180-a.

In the optical filter according to one embodiment of the present invention, the reflection of external light is caused by a difference of refractive indices between the support layer 10 and the structure 24. An angle for satisfying total reflection conditions is determined by a ratio between refractive indices of the support layer 10 and the structure 24. As the refractive index of the structure 24 is greater than that of the support layer 10, the angle increases as the refractive index of the structure 24 increases. Therefore, reflection paths may be easily adjusted by adjusting the ratio of refractive indices.

When the display device is positioned at a level consistent with that of a user's eyes, most light sources such as the sun and lamps are generally positioned above the display device. Therefore, if the first surface 24a of the structure 24 corresponds to the direction of an incident light source, total reflection of external light may be possible. In the optical filter according to an embodiment of the present invention, since the structure 24 is formed of a material having a high transmittance, luminance loss may be minimized or reduced when light generated by the display is radiated through the structure 24. In some tests, the optical filter of an embodiment of the present invention improved effectiveness by 37% to 48%, compared to conventional optical filters.

In a conventional optical filter, regions with limited viewing angles may be abundant, where the viewing angle may be limited to, for example, 120 to 125 degrees, and intervals between black stripes may be reduced to increase ambient contrast. However, since the structure 24 of embodiments of the present invention is formed of a material having a high transmittance, the optical filter according to an embodiment of the present invention may reduce regions with limited viewing angles, when compared to conventional optical filters.

While the present invention has been described in connection with certain exemplary embodiments, it is to be understood that the invention is not limited to the disclosed embodiments, but instead is intended to cover various modifications and equivalent arrangements included within the spirit and scope of the appended claims, and equivalents thereof.

What is claimed is:

1. An optical filter comprising:
a support layer; and
a plurality of stripe-shaped structures on one surface of the support layer and comprising a material having a refractive index different from a refractive index of the support layer,
wherein incident light is reflected at an interface between the support layer and each of the plurality of stripe-shaped structures due to the different refractive indices.

2. The optical filter as claimed in claim 1, wherein the support layer has a transmittance of at least 90%.

3. The optical filter as claimed in claim 1, wherein the refractive index of the plurality of stripe-shaped structures is greater than the refractive index of the support layer.

4. The optical filter as claimed in claim 1, wherein the plurality of stripe-shaped structures comprises a glass having a transmittance of at least 80%, a plastic material, a silicon, or a copolymer thereof.

5. The optical filter as claimed in claim 4, wherein the plastic material comprises one selected from the group consisting of polyethylene terephthalate (PET), cellulose triacetate (TAC), polycarbonate (PC), polymethyl methacrylate (PMMA), and combinations thereof.

6. The optical filter as claimed in claim 1, further comprising a transparent layer disposed on the one surface of the support layer and containing the plurality of stripe-shaped structures.

7. The optical filter as claimed in claim 1, further comprising:
a protective layer on the plurality of stripe-shaped structures; and
a functional layer on the protective layer.

8. The optical filter as claimed in claim 7, wherein the functional layer comprises at least one of an anti-reflection layer or a hard coating layer.

9. The optical filter as claimed in claim 1, wherein each of the plurality of stripe-shaped structures comprises:
a first surface at which incident light enters, the first surface configured to be at an angle to the support layer;
a second surface opposite the support layer; and
a third surface at which light reflected at an interface between the support layer and the second surface is reflected back through the first surface.

10. The optical filter as claimed in claim 9, wherein at least one of the first, second, and third surfaces is colored.

11. A plasma display device comprising:
a plasma display panel comprising a plurality of sustain electrodes, each of the plurality of sustain electrodes paired with a corresponding one of a plurality of scan electrodes, a plurality of address electrodes crossing the plurality of sustain electrodes and the plurality of scan electrodes, and a plurality of discharge spaces at crossing regions of the plurality of address electrodes with the plurality of sustain electrodes and the plurality of scan electrodes; and
an optical filter on the plasma display panel, the optical filter comprising:
a support layer; and
a plurality of stripe-shaped structures on one surface of the support layer and comprising a material having a refractive index different from a refractive index of the support layer,
wherein incident light is reflected at an interface between the support layer and each of the plurality of stripe-shaped structures due to the different refractive indices.

12. The plasma display device as claimed in claim 11, wherein the support layer has a transmittance of at least 90%.

13. The plasma display device as claimed in claim 11, wherein the refractive index of the plurality of stripe-shaped structures is greater than the refractive index of the support layer.

14. The plasma display device as claimed in claim 11, wherein the plurality of stripe-shaped structures comprises a glass having a transmittance of at least 80%, a plastic material, a silicon, or a copolymer thereof.

15. The plasma display device as claimed in claim 14, wherein the plastic material comprises one selected from the group consisting of polyethylene terephthalate (PET), cellulose triacetate (TAC), polycarbonate (PC), polymethyl methacrylate (PMMA), and combinations thereof.

16. The plasma display device as claimed in claim 11, wherein the optical filter further comprises a transparent layer disposed on the one surface of the support layer and containing the plurality of stripe-shaped structures.

17. The plasma display device as claimed in claim 11, wherein the optical filter further comprises:
a protective layer on the plurality of stripe-shaped structures; and
a functional layer on the protective layer.

18. The plasma display device as claimed in claim 17, wherein the functional layer comprises at least one of an anti-reflection layer or a hard coating layer.

19. The plasma display device as claimed in claim 11, wherein each of the plurality of stripe-shaped structures comprises:
a first surface at which incident light enters, the first surface configured to be at an angle to the support layer;
a second surface opposite the support layer; and
a third surface at which light reflected at an interface between the support layer and the second surface is reflected back through the first surface.

20. The plasma display device as claimed in claim 19, wherein at least one of the first, second, and third surfaces is colored.
